(19) United States
(12) Patent Application Publication
(10) Pub. No.: US 2017/0193754 A1
(43) Pub. Date: Jul. 6, 2017

(54) METHODS FOR PLAYING BACCARAT POKER GAME

(71) Applicant: eToyLab Inc., Seoul (KR)

(72) Inventor: Seung Yup Ryu, Seoul (KR)

(21) Appl. No.: 14/987,140

(22) Filed: Jan. 4, 2016

(51) Int. Cl. G07F 17/32; A63F 1/00

(52) U.S. Cl. CPC G07F 17/3293; A63F 1/00; G07F 17/3244; A63F 2001/001; A63F 2001/005

(57) ABSTRACT

Methods are provided for playing a card game not only on the internet but also in any offline places such as a casino and the like, and particularly provides methods for playing a new Baccarat Poker game that determines the ranking with two or three cards dealt as in Baccarat wherein the ranking is also competed by betting as in a poker game.

### BACKGROUND OF INVENTION

1. Field of the Invention

The present invention relates to new methods for playing a card game not only on the internet but also in any offline places such as a casino and the like, and more particularly to methods for playing a new Baccarat Poker game that determines the ranking with two or three cards dealt as in Baccarat wherein the ranking is also competed by betting as in a poker game.

2. Description of the Related Art

Baccarat has been well known as the simplest game. Baccarat uses a standard deck of 52 playing cards. Two or three cards are usually dealt to the Banker and Player hands respectively by the Baccarat rule from a shoe having multiple decks (e.g., 8 decks) that have been shuffled together prior to the beginning of play. The winning hand is determined by the higher value in the last digit of the total value of the dealt 2 or 3 cards. The bettor receives even money for his wager from the game operator (i.e., a game establishment operator such as a casino, an online server operator or the like, hereinafter, abbreviated to “a casino”) if he selects the winning hand and loses his wager if he selects the losing hand.

The Baccarat rule provides the conditions a third card is to be dealt (refer to U.S. Pat. No. 5,362,064) and the Banker hand has a slightly higher chance of winning than the Player hand. Therefore, if the bettor wagers on the Banker hand, he must pay to the casino a commission (typically, 5%) of the amount that he won.

In Baccarat, before dealing the cards to the Banker and Player hands by the dealer, the bettor must select one hand of Banker, Player and Tie and wager. In order to improve the problem of this prior bet, techniques for allowing a late bet when determining the third card to draw according to the Baccarat rules are disclosed in U.S. Pat. Nos. 8,087,985, 8,152,617, 8,353,517 and 8,657,292.

In the late bet according to the above U.S. patents, there still remains a problem that the bettor must rely on the chance only and wager in a blind state the values of two cards dealt in the selected hand and an additional third card are not known to him.

And, on the attributes of the game, because Baccarat is a zero-sum game in which the casino competes against the users rather than the user plays against the other users, if the user wins many times, the casino has no choice but to lose.

On the other hand, the poker game allows the user to compete against the other users. Because the casino has a structure to raise revenue by taking a commission called a rake in every round of play (typically, 5% of the pot money but limited to 3 dollars in every round), though many users win many times, the casino has no loss.

Among the poker games Texas Hold'em has gained wide spread popularity. Texas Hold'em is a game in which players wager and make a best hand from 2 hole cards dealt face-down and 3 cards selected in the 5 community cards. Recently, for the more the rakes collected by the more the competition between the users, the casino contrives and offers new kinds of poker games such as Omaha etc.

The poker games have an advantage that players can wager after seeing the cards in their hand and the community cards. However, because, before placing a bet, the player has to calculate the odds of winning by predicting the cards of the other players and a next dealing card etc., it gives a heavy burden to the player. In addition, there is a disadvantage that the winning is depended on the player's ability of the poker game.

### SUMMARY OF THE INVENTION

The present invention is to provide methods for playing a new Baccarat Poker game that determines the ranking with two or three cards dealt as in Baccarat wherein the ranking is also competed by betting as in a poker game and to also provide methods for implementing it as an online game.

To achieve the object, a method of playing a Baccarat Poker game according to the present invention comprises the steps of: dealing a first card in a predetermined direction each to players who participate in the game and permitting the players to wager sequentially along the direction as a first betting round, when no more Raises are made until the last player in the first betting round, dealing a second card in the direction each to the players who have not chosen Fold and permitting the players to wager as a second betting round, when no more Raises are made until the last player in the second betting round, permitting the players who have not chosen Fold to select Stay or Hit along the direction, dealing a third card each to the players who has selected Hit and permitting the players who have not chosen Fold to wager sequentially as a third betting round, and when no more Raises are made until the last player in the third betting round, determining the winner by showing face values of the cards of the players who have not chosen Fold until the third betting round.

The winner may be determined by the higher value in the last digit of the total value of cards dealt to each player, and wherein, in the case of three-of-a-kind (a hand with 3 cards having the same card value), AAA, KKK, QQQ, . . . , 333 and 222 may be sequentially ranked higher than any values in the last digit of the total value of cards dealt to each player and when the values in the last digit are the same, a player with 3 cards wins a player with 2 cards.

All of the players who participate in the game may place an Ante bet of a predetermined amount of money as a participation fee into a pot before dealing the first card.

The last betting player may be selected among the players who participate in the game and a Dealer Button may be placed at the last betting player, wherein two players at the left side of the Dealer Button may place wagers of Small and Big Blinds sequentially as additional duty bets, and wherein the Big Blind bet may be twofold of the Small Blind bet.

The first betting round may be performed to deal the first card in a clockwise direction from a player who wagered the Small Blind and to permit to wager one of Check, Fold, Call and Raise from a player at the left side of a player who wagered the Big Blind.

If a game is to be continued after determining the winner, the betting positions of the Small and Big Blinds may be newly decided by moving the Dealer Button in the clockwise direction.

In each of the betting rounds, an all-in player who has betted all the remaining chips in the pot may have a limited right on the pot within the amount of betting money.

A method for implementing a Baccarat Poker game as an online game by using a server connected to a plurality of user terminals by wire or wireless communication means, wherein the server is operated by a control program comprising the steps of: receiving Ante-bet signals from the user terminals and displaying Ante bets placed by players on a pot; selecting the last betting player among the players and marking with a Dealer Button; guiding to place wagers of Small and Big Blinds as additional duty bets sequentially from two players at the left side of the Dealer Button, receiving signals for the additional duty bets and displaying the Small and Big Blind bets on the pot; dealing a first card from a player who wagered the Small Blind in a clockwise direction, receiving bet signals in a first betting round, and displaying the bets on the pot; when no more Raises are made until the last player in the first betting round, dealing a second card in the direction each to the players who have not chosen Fold, receiving bet signals in a second betting round, and displaying the bets on the pot; when no more Raises are made until the last player in the second betting round, permitting the players who have not chosen Fold to select Stay or Hit along the direction, dealing a third card each to the players who have selected Hit, receiving bet signals in a third betting round, and displaying the bets on the pot; and when no more Raises are made until the last player in the third betting round, determining the winner by showing face values of the cards of the players who have not chosen Fold until the third betting round and displaying the winner on the pot.

The winner determination step may comprise: after receiving a bet signal of last player in the third betting round and displaying the bet on the pot, analyzing whether there are players with 3 cards among the players who have not chosen Fold until the third betting round, if there are the players with three-of-a-kind, determining the winner by a ranking in order of AAA, KKK, QQQ, . . . , 333 and 222, and if there are not the players with 3 cards or three-of-a-kind, determining the winner by the higher value in the last digit of the total value of cards dealt to each player.

The additional duty bets of the Small and Big Blinds may be automatically wagered by the control program and if a game is to be continued after determining the winner, the betting positions of the Small and Big Blinds may be newly decided by moving the Dealer Button in the clockwise direction.

The present invention can have no loss in a casino because users compete against each other rather than the casino by determining the ranking with two or three cards dealt as in Baccarat wherein the ranking is also competed by betting as in a poker game. According to the present invention, because the winning depends on some of the chance, the users can reduce the burden of complex calculation of the odds in the poker game and the casino can raise revenue by increasing the game participating frequency.

### BRIEF DESCRIPTION OF THE DRAWINGS

FIG. 1 is a flow chart of a control program showing a method for implementing a Baccarat Poker game as an online game according to an embodiment of the present invention.

FIG. 2 is a flow chart showing an exemplary for determining the winning in FIG. 1.

FIG. 3 is a block diagram showing a game system operated by the flow chart in FIG. 1.

### DETAILED DESCRIPTION OF THE PREFERRED EMBODIMENTS

Detailed descriptions of preferred embodiments of the present invention are provided below.

A Baccarat Poker game according to the present invention is a new card game that has not been known until now and that determines the ranking with two or three cards dealt as in Baccarat wherein the ranking is also competed by betting as in a poker game.

Cards used in the present invention can be the conventional cards used in the Baccarat or poker games, but not limited to. It may be cards consisted of more than 3 kinds classified by patterns or colors and configured to allocate face values 1 to 9, 12 or 13 or face values including those values. And, as a game of Baccarat, it can use a standard deck of 52 playing cards and can also use a shoe having multiple decks (e.g., 8 decks) that have been shuffled together prior to the beginning of play.

The Baccarat Poker game of the present invention basically has features that two or three cards are dealt to each player, that it is permitted for the players to see the dealt cards and to bet at each betting round dealing the cards as in a poker game such as Texas Hold'em, etc., and that the highest hand player among the finally competing players wins according to a predetermined winning rule.

Thus, the Baccarat Poker game of the present invention enables a casino to have no loss in any events because users compete against each other rather than the casino. According to the present invention, because the winning depends on some of the chance, the users can reduce the burden of complex calculation of the odds in the poker game and more often participate in the game. As a result, the casino can raise more revenue by the increasment of the game participation.

The Baccarat Poker game of the present invention can be played not only in specific places such as a casino and the like, but also by game facilities such as one or more game machines and the like as in Baccarat or a poker game. Thus, hereinafter, it is omitted to descript the means generally used in the conventional game such as Baccarat or a poker game etc. Detailed descriptions on methods of playing a Baccarat Poker game according to embodiments of the present invention are provided below.

A first card is dealt in a predetermined direction each to players who participate in the game and the players are permitted to wager sequentially along the direction as a first betting round.

Here, the players who participate in the game can just receive the first card and then place their wagers in the first betting round. However, before dealing the first card, all of the players who participate in the game can place an Ante bet of a predetermined amount of money as a participation fee into a pot and then the first card can be dealt each to the players who placed the Ante bet. In the latter, it has advantages to raise the basic pot money and to clearly define players among the participators.

In the first betting round dealing the first card each to players who participate in the game, first, the last betting player can be selected among the players who participate in the game and a Dealer Button can be placed at the last betting player. Here, the player having the Dealer Button can deal the cards. But, the cards can be dealt by a third person or thing and the Dealer Button can be used to simply display a criterion of a betting order. The dealing order of cards can be an anticlockwise direction, but as the conventional card games, it is preferable that the cards are dealt in a clockwise direction.

In the case of setting a criterion of a betting order with the Dealer Button, the first card can be just dealt each to the players for the first betting round. But, before dealing the first card, two players at the left side of the Dealer Button can place wagers of Small and Big Blinds sequentially as additional duty bets, i.e., a player at the left side of the Dealer Button can place the Small Blind bet and another player at the left side of the Small Blind betting player can place the Big1 Blind bet. Here, the Big Blind bet can be twofold of the Small Blind bet.

In the latter embodiment, when the additional duty bets of the Small and Big Blinds are placed, the first betting round can be progressed to deal the first card in a clockwise direction each to the players from the Small Blind betting player and to permit to choose and to wager one of Check, Fold, Call and Raise from a player at the left side of the Big Blind betting player. At this time, the limit of an amount of Raise can be a Pot Limit or a No Limit, etc., according to a predetermined rule, but it is basically the Pot Limit.

For one embodiment, when the first bets are sequentially placed with one of Check, Fold and Call until the Small Blind betting player, the Big Blind betting player can select one of Check, Fold and Raise. If any player has placed Raise, the Big Blind betting player has to select one of Fold, Call and Raise. The first betting round is ended if the other players except the last Raise betting player have not further placed Raise for a turn.

Continuously, when no more Raises are made until the last player in the first betting round, a second betting round can be progressed to deal a second card in the direction (i.e., in the clockwise direction) each to the players who have not chosen Fold and to permit the players to wager again.

The second card is dealt from a player at the left side of the Dealer Button among the players who have not chosen Fold in the clockwise direction and each of the players can see the first and second cards and wager along the dealing sequence of the second card.

When no more Raises are made until the last player in the second betting round, a third betting round can be progressed to permit the players who have not chosen Fold to select Stay or Hit along the direction (i.e., in the clockwise direction), to deal a third card each to the players who have selected Hit and to permit the players who have not chosen Fold to wager again sequentially.

Here, the Stay or Hit selection is given to the players who have not chosen Fold until the second betting round. And the chance to have the third card is given to the player(s) who has (have) selected Hit. Thus, the interesting and immersion in the game can be more raised.

When no more Raises are made until the last player in the third betting round, the winner can be determined by showing face values of the cards of the players who have not chosen Fold until the third betting round. The face values of the cards can be shown in the clockwise direction from a player at the left side of the Dealer Button among the players who have not chosen Fold until the third betting round, but not limited to, it can be shown up at the same time or without a certain sequence.

The winner can be determined by the highest hand made with 2 or 3 cards dealt each of the players who have not chosen Fold until the third betting round in the rankings defined by a predetermined winning rule.

Here, the winning rule can be variously prescribed including the Baccarat winning rule. The winner can be determined by the higher value in the last digit of the total value of cards dealt to each player. The last digit of the total value of cards dealt is earned by subtracting 10 or 20 from the total value of 2 or 3 cards dealt if the total value is over 10 or 20. For example, when a player who has received 4 and 5 values of cards competes against another player who has received 2, 4 and 9 values of cards, the former has 4+5=9, and the latter has 5 of the last digit subtracting 10 from the total 2+4+9=15. Thus, the former is the winner with the higher value in the last digit of the total value of the received cards. When using 52 playing cards of a poker game, J (Jacks), Q (Queens) and K (Kings) are equal to a ten card having a face value 10.

If the winning rule of the Baccarat Poker game according to the present invention contains only the Baccarat winning rule, it would be very simple and the players would lose the interesting of the game and drop down a desire of additional betting (the third betting round) with 3 cards by selecting Hit. Thus, it is preferably that the winning rule of the present invention has the rankings higher than those made by the Baccarat winning rule with 3 cards.

An exemplary higher ranking made with 3 is three-of-a-kind (called ‘triple’, three cards of the same rank regardless of suit). In this case, it can be prescribed that AAA, KKK, QQQ, . . . , 333 and 222 are sequentially ranked higher than any values in the last digit of the total value of the received cards.

When the values in the last digit made with the received 2 or 3 cards are the same, it can be prescribed that a player with 3 cards wins a player with 2 cards. For example, when a player who has received 3 and 6 values of 2 cards competes against another player who has received 2, 3 and 4 values of 3 cards, although the two players have the same value 9 in the last digit of the total value, the latter with 3 cards is to be the winner.

As the winning rule of the Baccarat Poker game according to the present invention, when it includes the Baccarat winning rule, three-of-a-kind ranking and the wining rule of a player with 3 cards if the values in the last digit of the total value of the received cards are equal to each other, the case of Tie in Baccarat can also compete to determine the winner and, as described above, the interesting and immersion in the game can be more raised. And it has an advantage to give a desire of betting continuously until the additional betting (i.e., the third betting round).

In each of the betting rounds, an all-in player who has betted all the remaining chips in the pot can have a limited right on the pot within the amount of betting money. But, although the all-in player has a hand higher than those of the other players, the right on the betting money of the other players after the all-in bet does not belong to the all-in player.

If a game is to be continued after determining the winner, the betting positions of the Small and Big Blinds can be newly decided by moving the Dealer Button in the clockwise direction.

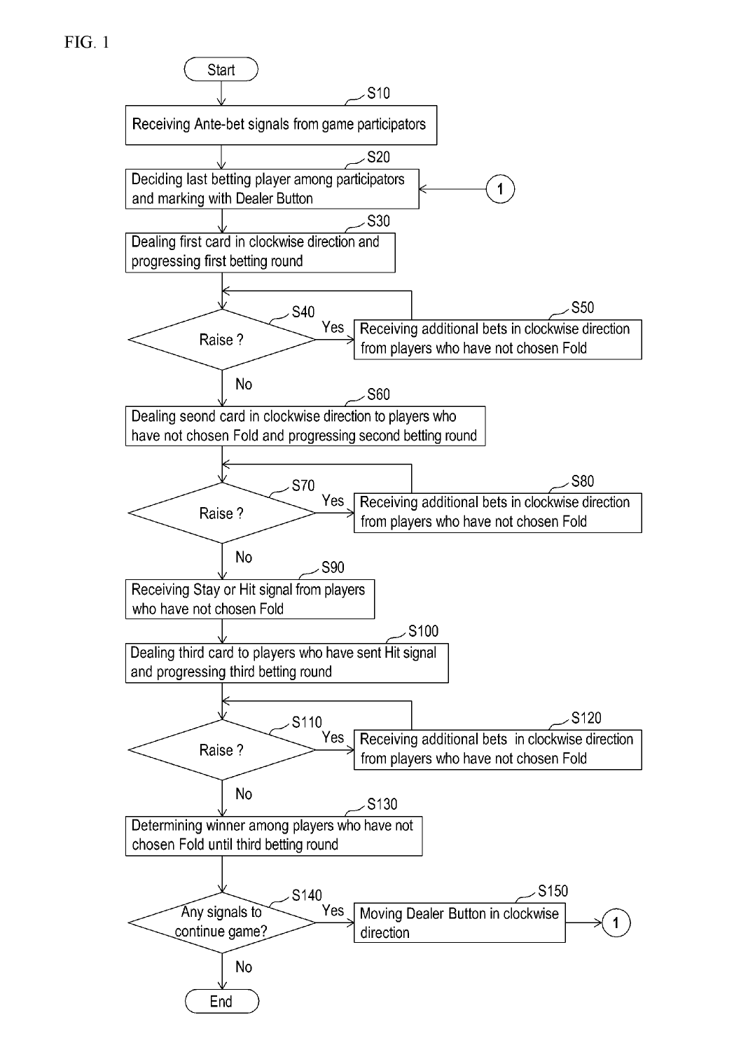

Next, detailed descriptions on methods for playing a Baccarat Poker game as an online game according to the present invention are provided with FIGS. 1 to 3.

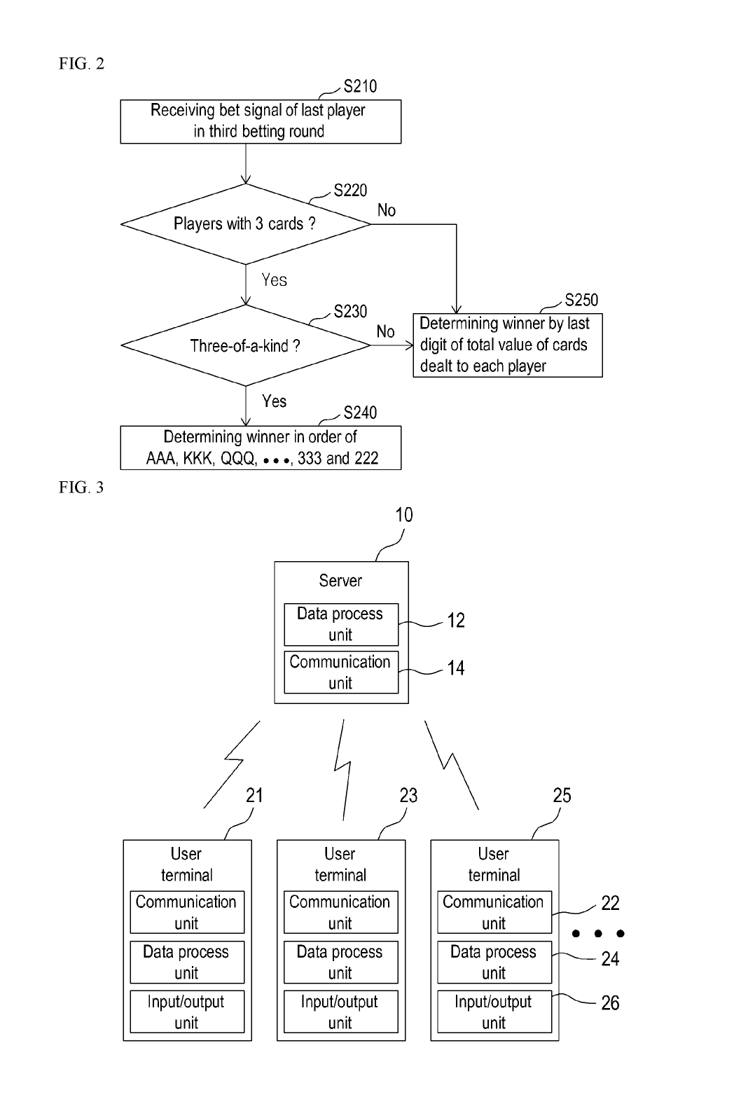

FIG. 1 is a flow chart of a control program showing a method for implementing a Baccarat Poker game as an online game according to an embodiment of the present invention, FIG. 2 is a flow chart showing an exemplary for determining the winning in FIG. 1 and FIG. 3 is a block diagram showing a game system operated by the flow chart in FIG. 1.

A game system for implementing a Baccarat Poker game according to the present invention as an online game, as shown in FIG. 3, can comprise a sever 10 and a plurality of user terminals 21, 23 and 25 connected to the server 10 by wire or wireless communication means.

Here, the serve 10 can comprise a data process unit 12 having a control program for a game control and a data processing and a communication unit 14 for a wire or wireless communication to the plurality of user terminals 21, 23 and 25.

Each of the user terminals 21, 23 and 25 includes a communication unit 22 for a wire or wireless communication to a server 10, a data process unit 24 for a game control and a data processing by predetermined application programs (e.g., apps) saved in the server 10 or an interior or exterior memory device of the user terminals, and an input/output unit 26 consisted of a display and game control command input means such as a touch pad and the like. For example, the user terminals 21, 23 and 25 can be an exclusive game apparatus, a personal computer, or a mobile device (e.g., a smart phone, PDA, a tablet, an electric pad, etc.).

By the control program saved in the serve 10 or the user terminals 21, 23 and 25, as shown in FIG. 1, Ante-bet signals for each player to bet a predetermined amount of money as a participation fee are received from the user terminals 21, 23 and 25. And the Ante bets are displayed on a pot for confirming the game players (S10).

Continuously, the last betting player among the participating players is selected and marked with a Dealer Button (S20).

Next, as shown in FIG. 1, a first card can be just dealt in a clockwise direction and progress a first betting round (S30). But it is preferable to guide to place wagers of Small and Big Blinds as additional duty bets sequentially together with the Ante bets from a player at the left side of the Dealing Button, receive signals for the additional duty bets and display the Small and Big Blind bets on the pot.

And the additional duty bets of the Small and Big Blinds can be automatically wagered by the control program.

Continuously, it is determined whether Raise is made or not until the last player in the first betting round (S40). If Raise is made, the signals of additional betting are sequentially received in the clockwise direction from the players who have not chosen Fold and the additional bets are displayed on the pot (S50). And if no more Raises are made, for a second betting round, a second card is dealt in the direction each to the players who have not chosen Fold and bet signals of the second betting round are received and the bets are displayed on the pot (S60).

It is determined whether Raise is made or not until the last player in the second betting round (S70). If Raise is made, the signals of additional betting are sequentially received in the clockwise direction from the players who have not chosen Fold and the additional bets are displayed on the pot (S80). And if no more Raises are made, it is permitted for the players who have not chosen Fold to select Stay and Hit in the direction for a third betting round and the signals selecting Stay or Hit are received (S90).

Except players who have chosen Stay, a third card is dealt only each to players who have chosen Hit. Bet signals of the third betting round are received and the bets are displayed on the pot (S100).

It is determined whether Raise is made or not until the last Player in the third betting round (S110). If Raise is made, the signals of additional betting are sequentially received in the clockwise direction from the players who have not chosen Fold and the additional bets are displayed on the pot (S120). And if no more Raises are made, it is progressed to determine the winner among the players who have not chosen Fold until the third betting round (S130).

The winner determination step can be progressed as shown in FIG. 2. After receiving a bet signal of last player in the third betting round and displaying the bet on the pot (S210), it is analyzed whether there are players with 3 cards among the players who have not chosen Fold until the third betting round (S220). If there are players with 3 cards, it is analyzed again whether there are players with three-of-a-kind (S230). If there are players with three-of-a-kind, the winner is determined by a ranking in order of AAA, KKK, QQQ, . . . , 333 and 222 (S240).

And if there are not the players with 3 cards or three-of-a-kind, the winner is determined by the higher value in the last digit of the total value of cards dealt to each player (S250).

As described above, when the winner is determined, it is displayed on the pot. And as a conventional poker game, the chips staked on the pot are delivered to the winner and then it is determined whether there are any signals to continue the next game (S140).

Here, the signals to continue the next game may be those of Ante bets for a predetermined amount of money as a participation fee of the next game received within a predetermined time. In other words, when the Ante-bet signals for the next game are received within a predetermined time from the game participators, it returns to step S20 step for performing the next game. And if the Ante-bet signals are not received within the predetermined time, it is ended without performing the next game.

After determining the winner, if the next game is to be continued, the betting positions of the Small and Big Blinds can be newly decided by moving the Dealer Button in the clockwise direction in step S20 and displayed on the pot (S150). And then the next game can be performed.

What is claimed is:

1. A method of playing a Baccarat Poker game comprising the steps of:
dealing a first card in a predetermined direction each to players who participate in the game and permitting the players to wager sequentially along the direction as a first betting round,
when no more Raises are made until the last player in the first betting round, dealing a second card in the direction each to the players who have not chosen Fold and permitting the players to wager as a second betting round,
when no more Raises are made until the last player in the second betting round, permitting the players who have not chosen Fold to select Stay or Hit along the direction, dealing a third card each to the players who have selected Hit and permitting the players who have not chosen Fold to wager sequentially as a third betting round, and
when no more Raises are made until the last player in the third betting round, determining the winner by showing face values of the cards of the players who have not chosen Fold until the third betting round.

2. The method of claim 1, wherein the winner is determined by the higher value in the last digit of the total value of cards dealt to each player, and wherein, in the case of three-of-a-kind (a hand with 3 cards having the same card value), AAA, KKK, QQQ, . . . , 333 and 222 are sequentially ranked higher than any values in the last digit of the total value of cards dealt to each player and when the values in the last digit are the same, a player with 3 cards wins a player with 2 cards.

3. The method of claim 1, wherein all of the players who participate in the game place an Ante bet of a predetermined amount of money as a participation fee into a pot before dealing the first card.

4. The method of claim 3, wherein the last betting player is selected among the players who participate in the game and a Dealer Button is placed at the last betting player, wherein two players at the left side of the Dealer Button place wagers of Small and Big Blinds sequentially as additional duty bets, and wherein the Big Blind bet is twofold of the Small Blind bet.

5. The method of claim 4, wherein the first betting round is performed to deal the first card in a clockwise direction from a player who wagered the Small Blind and to permit to wager one of Check, Fold, Call and Raise from a player at the left side of a player who wagered the Big Blind.

6. The method of claim 5, wherein if a game is to be continued after determining the winner, the betting positions of the Small and Big Blinds are newly decided by moving the Dealer Button in the clockwise direction.

7. The method of claim 5, wherein, in each of the betting rounds, an all-in player who has betted all the remaining chips in the pot has a limited right on the pot within the amount of betting money.

8. A method for implementing a Baccarat Poker game as an online game by using a server connected to a plurality of user terminals by wire or wireless communication means, wherein the server is operated by a control program comprising the steps of:
receiving Ante-bet signals from the user terminals and displaying Ante bets placed by players on a pot;
selecting the last betting player among the players and marking with a Dealer Button;
guiding to place wagers of Small and Big Blinds as additional duty bets sequentially from two players at the left side of the Dealer Button, receiving signals for the additional duty bets and displaying the Small and Big Blind bets on the pot;
dealing a first card from a player who wagered the Small Blind in a clockwise direction, receiving bet signals in a first betting round, and displaying the bets on the pot;
when no more Raises are made until the last player in the first betting round, dealing a second card in the direction each to the players who have not chosen Fold, receiving bet signals in a second betting round, and displaying the bets on the pot;
when no more Raises are made until the last player in the second betting round, permitting the players who have not chosen Fold to select Stay or Hit along the direction, dealing a third card each to the players who has selected Hit, receiving bet signals in a third betting round, and displaying the bets on the pot; and
when no more Raises are made until the last player in the third betting round, determining the winner by showing face values of the cards of the players who have not chosen Fold until the third betting round and displaying the winner on the pot.

9. The method of claim 8, wherein the winner determination step comprises:
after receiving a bet signal of last player in the third betting round and displaying the bet on the pot, analyzing whether there are players with 3 cards among the players who have not chosen Fold until the third betting round,
if there are the players with three-of-a-kind, determining the winner by a ranking in order of AAA, KKK, QQQ, . . . , 333 and 222, and
if there are not the players with 3 cards or three-of-a-kind, determining the winner by the higher value in the last digit of the total value of cards dealt to each player.

10. The method of claim 8, wherein the additional duty bets of the Small and Big Blinds is automatically wagered by the control program and if a game is to be continued after determining the winner, the betting positions of the Small and Big Blinds are newly decided by moving the Dealer Button in the clockwise direction.
